(19) United States
(12) Patent Application Publication
(10) Pub. No.: US 2009/0164183 A1
(43) Pub. Date: Jun. 25, 2009

(54) Methodology for Thermal Modeling of On-Chip Interconnects Based on Electromagnetic Simulation Tools

(75) Inventors: Howard Smith, Beacon, NY (US); Lijun Jiang, Poughquag, NY (US); Alina Deutsch, Chappaqua, NY (US); Kaushik Chanda, Fishkill, NY (US); Barry Jay Rubin, Croton-on-Hudson, NY (US); Jason Gill, Lagrange, NY (US); Seshadri K. Kolluri, Goleta, CA (US)

Correspondence Address: PRTSI, INC, 4661 CARISBROOKE LN, FAIRFAX, VA, 22030, US

(73) Assignee: INTERNATIONAL BUSINESS MACHINES CORPORATION, Armonk, NY (US)

(21) Appl. No.: 12/037,753

(22) Filed: Feb. 26, 2008

Related U.S. Application Data
(60) Provisional application No. 61/015,367, filed on Dec. 20, 2007.

(51) Int. Cl. G06G 7/122

(52) U.S. Cl. 703/6

(57) ABSTRACT

A method and apparatus for thermal modeling of on-chip interconnects using electromagnetic tools to determine a temperature profile across the interconnect structure and the temperature at each node of an equivalent thermal circuit derived from an electrical model.

### FIELD OF INVENTION

The field of the invention is in the area of thermal modeling of electronic circuitry through an electrical analogy.

### BACKGROUND

Temperature rise due to current carrying interconnects and the associated effects on performance and reliability of interconnects are known as thermal effects. Current flow in a VLSI interconnect causes a power dissipation of I²R, where I is the current through the interconnect and R is the wire resistance. Since the interconnects, especially the global-tier interconnects, are far away from the substrate, which is attached to the heat sink, the heat generated due to this I²R power dissipation cannot be efficiently removed and therefore causes an increase in the interconnect temperature. This phenomenon is referred to as Joule heating or self-heating. The Joule heating effects are becoming significantly important with the shrinking scale of Integrated Circuit technology because of increasing on-chip power densities on the chip, inclusion of more metal layers and use of dielectric materials with lower thermal conductivities.

Joule heating is well-known for its impact on the interconnect lifetime through electromigration (EM) effect on reliability, that has a strong dependence on temperature. In addition to the reliability, thermal effects also impact the performance and design optimization of interconnects (Reference K. Banerjee, A. Mehrotra, A. Sangiovanni-Vincentelli and C. Hu, “On thermal effects in deep sub-micron VLSI interconnects,” Proceedings of ACM DAC, pp. 885-891, 1999 and K. Banerjee and A. Mehrotra, “Global (interconnect) warming,” IEEE Circuits and Devices Magazine, pp. 16-32, September 2001). Hence, the accurate and efficient modeling of temperature rise in interconnects because of Joule heating is critical to modern semiconductor industries.

Temperature distribution simulation for IC interconnects involves solving the three-dimensional (3D) or two-dimensional (2D) heat-conduction equation in a multi-level dielectric stack with interconnects, vias and metal fills embedded in it. While some analytical thermal models are available for multi-level interconnects, the 2D/3D nature heat-conduction in presence of such complicated structures is either neglected or treated approximately (Reference W. R. Hunter, “Self-consistent solutions for allowed interconnect current density-Part II: Application to design guidelines,” IEEE Transactions on Electron Devices, vol. 44, pp. 310-316, February 1997; C. C. Teng, Y. K. Cheng, E. Rosenbaum, and S. M. Kang, “iTEM: A temperature-dependent electromigration reliability diagnosis tool,” IEEE Transactions on Computer-Aided Design, vol. 16, no. 8, pp. 882-893, August 1997; D. Chen, E. Li, E. Rosenbaum and S. Kang, “Interconnect thermal modeling for accurate simulation of circuit timing and reliability,” IEEE Transactions on Computer-Aided Design, vol. 19, pp. 197-205, February 2000; and T. Y. Chiang, K. Banerjee and K. C. Saraswat, “Analytical thermal model for multilevel VLSI interconnects incorporating via effect,” IEEE Electron Device Letters, vol. 23, no. 1, pp. 31-33, January 2002).

Previous finite element thermal simulation approaches have confined themselves to smaller problems with fewer metal layers or used assumptions of symmetry for worst-case structures (Reference X. Gui, S. K. Dew, and M. J. Brett, “Three-dimensional thermal analysis of high density triple-level interconnection structures in very large scale integrated circuits,” Journal of Vacuum Science & Technology B, vol. 12, no. 1, pp. 59-62, January/February 1994 and S. Rzepka, K. Banerjee, E. Meusel, and C. Hu, “Characterization of self-heating in advanced VLSI interconnect lines based on thermal finite element simulation,” IEEE Transactions on Components, Packaging, and Manufacturing Technology Part A, vol. 21, no. 3, September 1998) due to tool limitations. And most methodologies were implemented by building tools dedicated to thermal analysis only.

Because of the analogy between electrical and thermal conduction problems, some methodologies use capacitance to obtain the thermal effects (Reference P. A. Habitz, “Electromigration Check of Signal Nets Using Net Capacitance to Evaluate Thermal Characteristics,” U.S. Pat. No. 7,089,129 B2, Aug. 8, 2006). However, because capacitive coupling can extend in the entire space, restrictive boundaries need to be introduced in the model in the case of boundary-element type of capacitance solvers. In such cases, capacitance can exist even without any dielectric, while thermal conduction will not occur in vacuum. Therefore, the analogy between capacitance and thermal resistance is not as accurate or direct as the analogy between electrical resistance and thermal resistance. In addition, these approaches are not readily integrated with on-chip CAD tools and design flows. Due to the extremely high integration density on chip, handling the resultant huge simulation structures becomes an intractable problem for most in-house and commercial tools, and traditionally people are forced to either look at small-sized problems or use approximate analytical models for thermal analysis.

We propose a novel methodology to use existing electromagnetic simulation tools for interconnect and packaging structures to simulate and model temperature distribution in interconnects without any major modifications to these tools as well as the simulation structure.

### SUMMARY

A method and apparatus for thermal modeling of on-chip interconnects using electromagnetic simulation tools. An embodiment of the method and apparatus provides geometry information for all the metal layers, dielectrics, vias and metal fills in a technology file. The embodiment of the method and apparatus provides physical properties of the metal layers, the dielectrics, the vias and the metal files in a material file. The technology file is generated from an interconnect analysis tool. Thermal conductivities information about the dielectrics is obtained from experimental measurements and is input through the material file. The embodiment of the method and apparatus further provides a script to read the technology file and the material file automatically to generate geometry and simulation parameters. The embodiment of the method and apparatus provides transformation from electrical domain to thermal domain. A 3-dimensional resistance solver is called by the script to perform a thermal analysis to generate an output selected from the group consisting of a temperature profile across the entire structure and an equivalent thermal circuit between desired nodes. The equivalent thermal circuit is used to determine the temperature at each node of the thermal network.

The invention contains a novel methodology for thermal modeling of on-chip interconnects using electromagnetic simulation tools. It uses the analogy between electrical and thermal problems and calculates the temperature distribution in the on-chip interconnects that are embedded in a multi-layer dielectric stack, with vias and metal fills. Electrical resistance is used to obtain the thermal resistance by substituting the electrical resistance with the material thermal conductivity. Any 2D/3D electrical resistance simulation solver which fully obeys the resistance Laplace equation will be qualified to accomplish this transformation. As the benchmark, we have used an existing 3D electrical resistance solver IBM's RGEN to verify this methodology. A tool is disclosed based on this methodology. A whole 10-layer, 45 nm, 2D stack has been simulated and convergent temperature distribution has been obtained in a very short calculation time.

This methodology can be fully integrated with existing tools for electrical analysis and does not require the users to construct additional simulation structures for thermal analysis. This methodology makes it possible to analyze large interconnect thermal problems, using the existing electromagnetic tools and geometry definitions, with very small additional effort.

### BRIEF DESCRIPTION OF THE DRAWINGS

FIG. 1: Flow-chart describing the implementation of the invented methodology

### DETAILED DESCRIPTION

### Methodology—Theory:

The method of this invention is based on analogy between electrical and thermal conduction problems. As shown in Poisson's equation below, the electrical charge can be transformed into the heat-equation, by transforming electric potential into temperature, electrical current into heat flow, electrical conductivity into thermal conductivity and electrical resistance into thermal resistance:

| | |
|---|---|
| Poisson's Equation | Heat Equation (Steady-State): |
| ∇(ε∇φ) = −ρ | ∇(κᵣₕ∇T) = −qᵣₕ″ |
| In the dielectric (Im. Part): | In the dielectric (No heat generation): |
| ∇(σₑₗ∇φ) = 0 | ∇(κᵣₕ∇T) = 0 |
| Electrical Current Density: | ThermalFlux: |
| $\frac{I}{A} = J = {σ}_{el} E = - {σ}_{el} \frac{\partial φ}{\partial x}$ | $\frac{q}{A} = {Φ}_{rh} = - {κ}_{rh} \frac{\partial T}{\partial x}$ |

Potential (φ) [symbol] Temperature (T)
Current (I) [symbol] Heat Flow (q)
Elec.Conductivity(σₑᵢ) [symbol] Thermal Conductivity (κᵣₕ)
Elec.Resistance(Rₑₗ) [symbol] Thermal Resistance (Rᵣₕ)

Hence, any tool, which is capable of solving Poisson's equation in a composite dielectric-stack with several metal layers, can be used to solve the temperature distribution in the same structure, by making necessary transformations to the input and output variables of the tool.

The existing resistive solver, namely RGEN from IBM Electrical Interconnect Packaging (EIP) Tool suite, has been used in the methodology of an exemplary embodiment of the present invention as described in later sections. In addition, a complete design flow, starting from the technology file to the simulated temperature distribution, has been established on top of this analogy methodology.

### Methodology—Implementation:

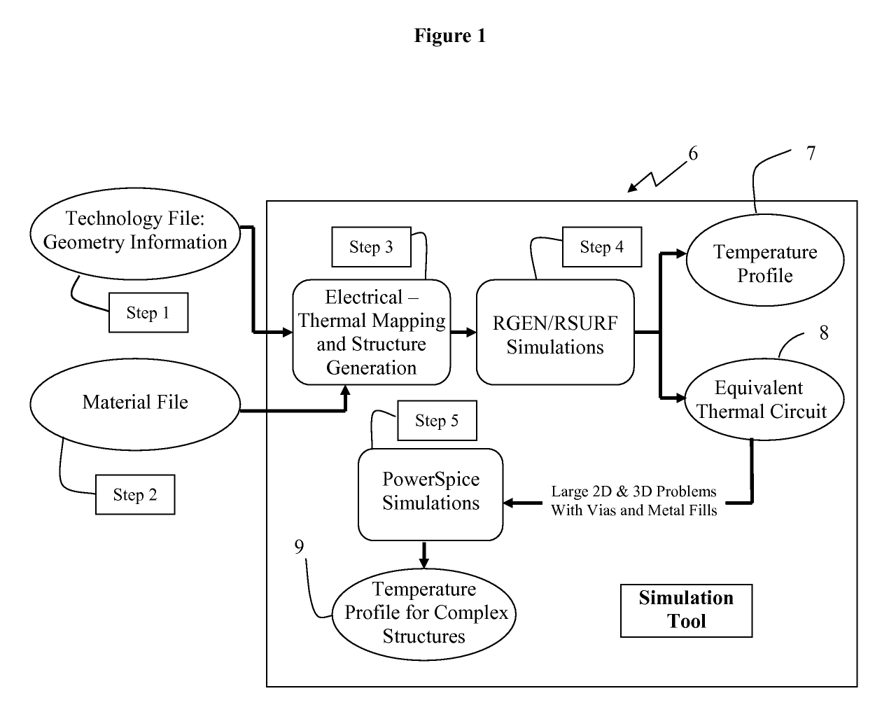

The analogy between electrical and thermal problems described in the previous section has been used to solve the thermal problem using EIP tools, according to the flow described in FIG. 1.

### Steps Involved:

Step 1: Geometry information for all the metal layers, dielectrics, vias and metal fills is obtained from a technology file. This technology file can be readily generated from the “AQUAIA” interconnect analysis tool that is already in use by persons of skill in the art.

Step 2: Information regarding thermal conductivities of different dielectric layers is obtained from experimental measurements and is input to the tool through the material file.

Step 3: A script has been written to read the input files into the simulation tool 6 and automatically generate the geometry and simulation parameters, after making the necessary transformations from electrical domain to thermal domain. This information is output in the form of an “.amoc” file, which is the standard model creation and execution format for the whole suite of EIP Tools.

Step 4: The 3-dimensional resistance solver, RGEN, is called by the script generated in the previous step to perform the thermal analysis. Based on the configuration options, the output of the simulator can either be the temperature profile across the entire structure 7, or just an equivalent thermal circuit between desired nodes 8.

Step 5: The equivalent thermal circuit can be duplicated and simulated along with other similar thermal circuit elements using PowerSpice, to yield the temperature at each node of the thermal network 9.

### CONCLUSION

This invention provides a novel methodology for thermal modeling of on-chip interconnects using electromagnetic tools, a methodology for using electrical resistance (Laplace Equation based) to simulate thermal resistance with the help of transformation of variables, an automated flow for calculating the temperature distribution of the on-chip interconnects from the technology and material information using a structure generator (such as the existing IBM EIP AMOC), a resistance solver (IBM EIP RGEN), a circuit simulator (such as IBM POWERSPICE, Maise, or HSPICE), a tool for automatic on-chip thermal modeling and guide lines for on-chip interconnect optimization, a methodology to extend existing electrical performance simulation framework into electrical/thermal performance simulation tool set, and a methodology to extend existing electromagnetic simulation tools to other physical modeling processes which share the similar fundamental philosophies,

This methodology can also be used to investigate 3D end effects, thermal profiles along the length of the interconnects, and effects of orthogonal wiring in adjacent layers.

This methodology can further be used to analyze transient effects for sudden surges in currents such as current discharge through ESD diodes, or simultaneous switching of many signal lines in a wide data bus, or from a large clock driver, or power-on or power off conditions when using power gating to reduce power consumption on chip.

1. A method for thermal modeling of on-chip interconnects using electromagnetic simulation tools, said method comprising:
providing geometry information for all the metal layers, dielectrics, vias and metal fills in a technology file;
providing physical properties of said metal layers, said dielectrics, said vias and said metal fills in a material file;
generating said technology file from an interconnect analysis tool;
obtaining thermal conductivities information about said dielectrics from experimental measurements;
inputting said information to said interconnect analysis tool through said material file;
providing a script to read said technology file and said material file automatically to generate geometry and simulation parameters in an electrical domain;
transforming the geometry and simulation parameters from the electrical domain to a thermal domain; and
calling a 3-dimensional resistance field solver, by said script, to perform a thermal analysis to generate one or more readable, digital output files selected from the group consisting of a thermal resistance network file, a thermal resistance summary file, a temperature profile file, and a file representing an equivalent thermal circuit of the on-chip interconnects between desired nodes.
